(19) United States
(12) Patent Application Publication
(10) Pub. No.: US 2026/0145774 A1
(43) Pub. Date: May 28, 2026

(54) ASSEMBLY FOR AN AIRCRAFT COMPRISING MEANS FOR FIXING A WING TO AN ENGINE PYLON

(71) Applicant: Airbus Operations SAS, TOULOUSE (FR)

(72) Inventors: Germain GUENEAU, TOULOUSE (FR); Pierre-Antoine COMBES, TOULOUSE (FR); Marc DE NICOLA, TOULOUSE (FR)

(21) Appl. No.: 19/401,516

(22) Filed: Nov. 26, 2025

(30) Foreign Application Priority Data
Nov. 28, 2024 (FR) FR2413136

(51) Int. Cl. B64C 3/32; B64D 27/18; B64D 27/40

(52) U.S. Cl. CPC B64C 3/32; B64D 27/402; B64D 27/18

(57) ABSTRACT

An assembly for an aircraft has an engine pylon with lateral panels and upper and lower longitudinal members, an additional bracket fixed to the structure of a wing, starboard and portside fork ends fixed to a structure and articulated on the associated lateral panel, a front link mounted in an articulated manner between the upper longitudinal member and the additional bracket, a rear link mounted in an articulated manner between the lower longitudinal member and the structure and a stud having an axis parallel to a vertical direction and having a proximal end integral with the upper longitudinal member and a distal end mounted in an aperture of the additional bracket via an annular linear connection. Also an aircraft with such an assembly.

### CROSS-REFERENCES TO RELATED APPLICATIONS

This application claims the benefit of French Patent Application Number FR 2413136 filed on Nov. 28, 2024, the entire disclosure of which is incorporated herein by way of reference.

### FIELD OF THE INVENTION

The present invention relates to an assembly for an aircraft comprising means for fixing a wing to an engine pylon, and an aircraft comprising a wing and such an assembly.

### BACKGROUND OF THE INVENTION

Conventionally, for an aircraft, a propulsion assembly comprises a turbojet which is fixed below a wing of the aircraft by means of an engine pylon. The engine pylon generally consists of a primary structure formed from a box consisting of an upper longitudinal member, a lower longitudinal member and two lateral panels connecting the two longitudinal members and internal ribs distributed along the box.

The turbojet is fixed below the engine pylon by means of engine mounts which conventionally comprise, at the front, a front engine mount, at the rear, a rear engine mount and, between the front and rear engine mounts, an assembly for absorbing thrust force comprising force-absorbing links which are fixed, on the one hand, to the turbojet and, on the other hand, to a shoe which is integral with the primary structure of the pylon in order to absorb the thrust forces generated by the turbojet. A fixing system connects the engine pylon to the wing. This fixing system reacts to and absorbs the bending moments and transverse forces at the interface of the engine pylon with the wing. An example of such an arrangement is described in the document US-A-2016/0221682.

While such fixing systems are satisfactory, it is desirable to find different arrangements, in particular for creating a hyperstatic architecture which multiplies the force transfer paths from the engine to the structure of the wing.

### SUMMARY OF THE INVENTION

A subject of the present invention is to propose an assembly for an aircraft comprising means for fixing a wing to an engine pylon, where the fixing means create a hyperstatic architecture.

To this end, an assembly for an aircraft is proposed, comprising a wing with a structure, said assembly having a vertical direction and a vertical median plane and comprising:
an engine pylon having a primary structure forming a box and comprising a starboard lateral panel, a portside lateral panel, an upper longitudinal member and a lower longitudinal member,
an additional bracket designed to be fixed to the structure of the wing,
a starboard fork end and a portside fork end arranged on either side of the vertical median plane, each being designed to be fixed to the structure of the wing and each being mounted in an articulated manner on the lateral panel which is on the same side,
a front link arranged in the vertical median plane, an upstream end thereof being mounted in an articulated manner on the upper longitudinal member and a downstream end thereof being mounted in an articulated manner on the additional bracket,
a rear link arranged in the vertical median plane, an upstream end thereof being mounted in an articulated manner on the lower longitudinal member and a downstream end thereof being designed to be mounted in an articulated manner on the structure of the wing, and
a stud having an axis parallel to the vertical direction and having a proximal end integral with the upper longitudinal member and a distal end mounted in an aperture of the additional bracket via an annular linear connection.

The force transfer paths are multiplied by such an assembly.

Advantageously, the stud is mobile in translation relative to the additional bracket parallel to a longitudinal direction.

Advantageously, the assembly comprises a ring which has a spherical external surface and which is fitted over the distal end of the stud, a nut which has a spherical internal surface in which the ring is housed, where on either side of the nut the external surface of the nut has a rib parallel to the longitudinal direction, where on the edges of the aperture the additional bracket has, for each rib, a recess extending parallel to the longitudinal direction in which said rib is guided in translation.

Advantageously, the stud consists of two half-cylinders which are contiguous along a plane, where the proximal end of each half-cylinder is fixed to the upper longitudinal member.

Advantageously, each articulation takes the form of a rotation about an axis perpendicular to the vertical median plane.

Advantageously, for each fork end, the assembly comprises a complementary link, a first end thereof being designed to be mounted in an articulated manner on the structure of the wing and a second end thereof being mounted in an articulated manner on the lateral panel which is on the same side.

Advantageously, each articulation of a complementary link is implemented by a complementary shaft which passes through a bore of said complementary link and a bore respectively of the associated lateral panel or the structure of the wing.

Advantageously, the bore of the complementary link corresponding to the connection to the lateral panel has a diameter which is greater than the diameter of the associated complementary shaft.

The invention also proposes an aircraft comprising a wing with a structure, a turbojet and an assembly according to one of the preceding variants, where the additional bracket is fixed to the structure of the wing, where each fork end is fixed to the structure of the wing, where the downstream end of the rear link is mounted in an articulated manner on the structure of the wing and where the turbojet is fixed below the engine pylon.

### BRIEF DESCRIPTION OF THE DRAWINGS

The features of the invention mentioned above and further features will become clearer by reading the following description of an exemplary embodiment, said description being made in relation to the accompanying drawings, in which:

FIG. 1 is a side view of an aircraft according to the invention,

FIG. 2 is a perspective and rear view of an assembly according to the invention,

FIG. 3 is a schematic side view of a variant of the invention,

FIG. 4 is a perspective view of a detail of the embodiment of the assembly according to the invention,

FIG. 5 shows the detail of FIG. 4 viewed in section through the plane V, and

FIG. 6 is an exploded view of certain elements of the detail of FIG. 4.

### DETAILED DESCRIPTION OF THE PREFERRED EMBODIMENTS

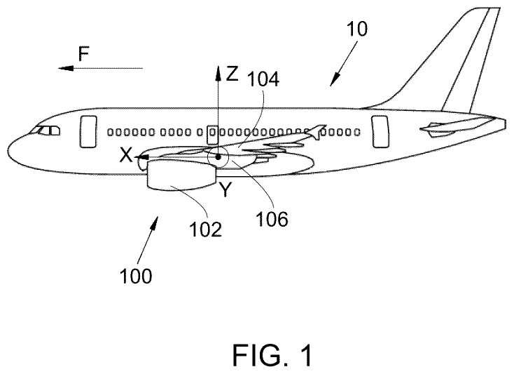

FIG. 1 shows an aircraft 10 which comprises a propulsion system 100 with a turbojet 102 connected to a wing 104 of the aircraft 10 by means of an engine pylon 106. The engine pylon 106 and the fixing means described below, which ensure the fixing of the engine pylon 106 to the wing 104, form an assembly according to the invention. The turbojet 102 is fixed below the engine pylon 106.

In the following description, the terms relative to a position refer to an aircraft in the normal flight position, i.e. as shown in FIG. 1 and the positions “front” and “rear” are relative to the front and the rear of the turbojet and relative to the forward direction of travel F of the aircraft 10 when the turbojet 102 is in operation.

In the following description, and by convention, X is the longitudinal direction of the assembly which is parallel to the longitudinal axis of the turbojet, Y is the transverse direction which is horizontal when the aircraft is on the ground, and Z is the vertical direction which is vertical when the aircraft is on the ground, these three directions X, Y and Z being at right-angles to one another.

The turbojet 102 has a shape of revolution about its longitudinal axis.

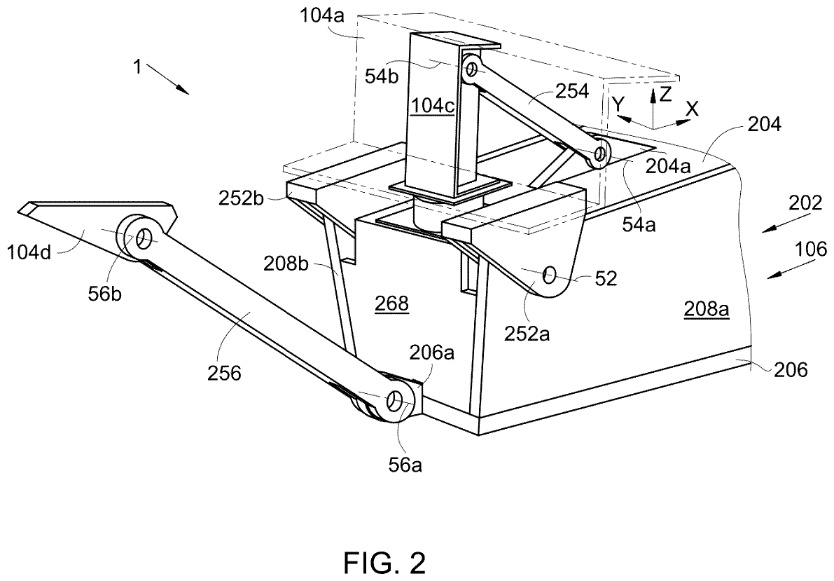

FIG. 2 shows the assembly 1 according to the invention.

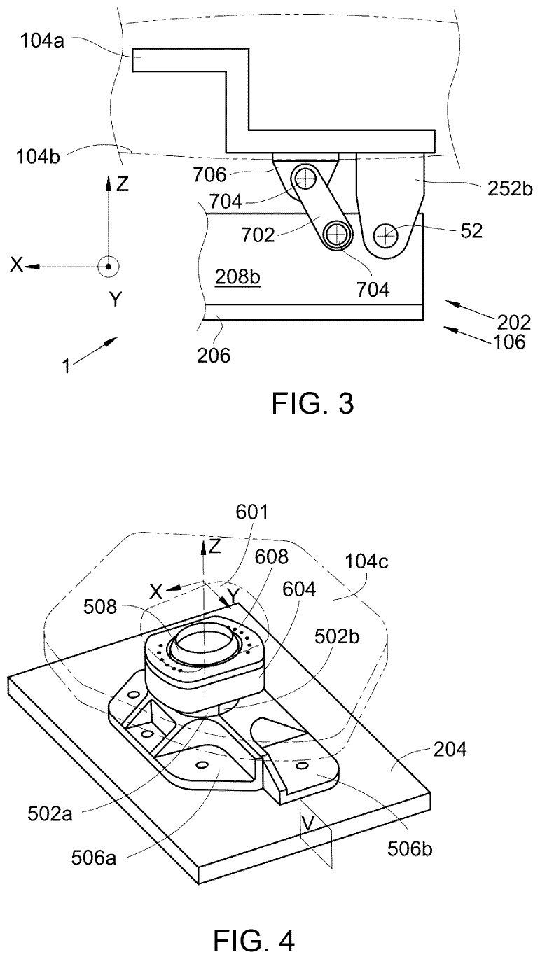

As FIG. 2 and FIG. 3 show, the wing 104 has a structure 104a (visible in dot-dashed lines in FIG. 2) which is rigid and in this case takes the form of longitudinal members extending in the transverse direction Y. The wing 104 also has an under-wing panel 104b (in dot-dashed lines in FIG. 3) which covers at least partially the lower part of the structure 104a. Conventionally the wing 104 also comprises an over-wing panel which covers at least partially the upper part of the structure 104a.

The engine pylon 106 comprises a rigid structure 202 forming a box and also called the primary structure. The primary structure 202 is formed from an upper longitudinal member 204, a lower longitudinal member 206 and a starboard lateral panel 208a and a portside lateral panel 208b connecting the two longitudinal members 204 and 206. The primary structure 202 can also comprise internal ribs distributed inside the primary structure 202 and connected to the longitudinal members 204 and 206 and to the lateral panels 208a-b. The primary structure 202 also comprises a rear rib 268 which closes the box at the rear and which is generally perpendicular to the longitudinal direction X.

The primary structure 202 is generally symmetrical relative to a median plane XZ of the assembly 1 which extends vertically.

The primary structure 202 supports the turbojet 102 by means of engine mounts which can be of conventional design, such as those disclosed in the document US-A-2016/0221682.

The cascade fixing of the turbojet 102 to the engine pylon 106 and then to the structure 104a of the wing 104 ensures the transfer of forces from the turbojet 102 to the wing 104.

The assembly 1 also comprises a starboard fork end 252a and a portside fork end 252b, where each is fixed rigidly to the structure 104a of the wing 104 by any appropriate means such as screwing elements, welding points, etc. Each fork end 252a-b can be fixed directly to the structure 104a of the wing 104 or by means of intermediate brackets.

Each fork end 252a-b is also mounted in an articulated manner on the lateral panel 208a-b of the primary structure 202 which is on the same side. The fork ends 252a-b are thus arranged on either side of the vertical median plane XZ. The articulations of the two fork ends 252a-b relative to the lateral panels 208a-b in this case take the form of a rotation about the same axis of articulation 52 which is perpendicular to the vertical median plane XZ and thus parallel to the transverse direction Y.

These articulations ensure the transfer of forces in Z and in X. The fork ends 252a-b are arranged in the region of the rear part of the primary structure 202 in the vicinity of the rear rib 268. Each articulation of a fork end 252a-b is implemented in this case by a lateral shaft (not shown) which passes through a bore of the associated lateral panel 208a-b and a bore of said fork end 252a-b. Thus two lateral shafts are arranged on either side of the vertical median plane XZ.

In this case, each fork end 252a-b constitutes a female fork end into which the associated lateral panel 208a-b, which thus forms a male fork end, is fitted.

The assembly 1 also comprises a front link 254 which comprises an upstream end and a downstream end. The upstream end is mounted in an articulated manner on the upper longitudinal member 204 and the downstream end is mounted in an articulated manner on the structure 104a of the wing 104.

The articulation on the structure 104a is implemented in this case by means of an additional bracket 104c fixed to the structure 104a. The front link 254 is arranged in the vertical median plane XZ.

The articulation of the front link 254 in the region of its upstream end and the articulation of the front link 254 in the region of its downstream end in this case each take the form of a rotation respectively about an upstream axis of articulation 54a and a downstream axis of articulation 54b which are perpendicular to the vertical median plane XZ and thus parallel to the transverse direction Y.

The front link 254 ensures the transfer of axial forces according to X. The upstream end of the front link 254 is located toward the front and toward the bottom relative to the downstream end of the front link 254.

Each articulation of the front link 254 is implemented in this case by a shaft and thus there is one upstream shaft and one downstream shaft (not shown), where the upstream shaft passes through a bore of an upper bracket 204a integral with the upper longitudinal member 204 and a bore of the upstream end of the front link 254 and where the downstream shaft passes through a bore of the additional bracket 104c and a bore of the downstream end of the front link 254.

In this case, each end of the front link 254 constitutes a female fork end in which the upper bracket 204a and the additional bracket 104c are respectively fitted, each thus forming a male fork end.

The assembly 1 also comprises a rear link 256 which comprises an upstream end and a downstream end. The upstream end is mounted in an articulated manner on the lower longitudinal member 206 and the downstream end is mounted in an articulated manner on the structure 104a of the wing 104. The articulation on the structure 104a is implemented in this case by means of an additional bracket 104d fixed to the structure 104a. The rear link 256 is arranged in the vertical median plane XZ.

The articulation of the rear link 256 in the region of its upstream end and the articulation of the rear link 256 in the region of its downstream end each take the form of a rotation respectively about an upstream axis of articulation 56a and a downstream axis of articulation 56b which are perpendicular to the vertical median plane XZ and thus parallel to the transverse direction Y.

The rear link 256 ensures the transfer of axial forces along X. The upstream end of the rear link 256 is located toward the front and toward the bottom relative to the downstream end of the rear link 256.

Each articulation of the rear link 256 is implemented in this case by a shaft and thus there is one upstream shaft and one downstream shaft (not shown), where the upstream shaft passes through a bore of a rear bracket 206a integral with the lower longitudinal member 206 and a bore of the upstream end of the rear link 256 and where the downstream shaft passes through a bore of the additional bracket 104d and a bore of the downstream end of the rear link 256. In this case, each end of the rear link 256 constitutes a female fork end in which the rear bracket 206a and the additional bracket 104d are respectively fitted, each thus forming a male fork end.

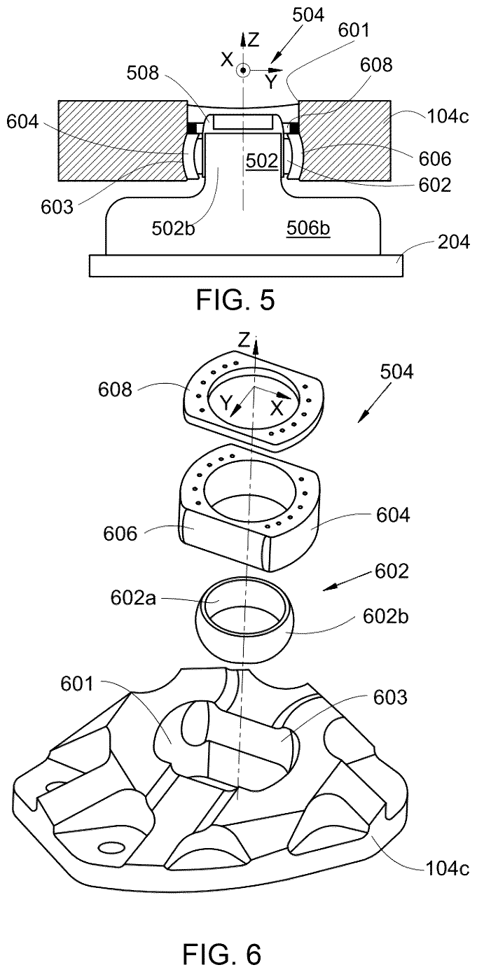

The fixing of the engine pylon 106 to the wing 104 is also ensured by a stud 502 (FIGS. 4 and 5) in the form of a straight cylinder, the axis thereof being parallel to the vertical direction Z. The stud 502 has a proximal end integral with the upper longitudinal member 204 and a distal end mounted in an aperture 601 of the structure 104a of the wing 104 and, more particularly in this case, of the additional bracket 104c via an annular linear connection 504, i.e., the stud 502 is mounted in the aperture 601 via a ball-joint connection and the stud 502 is also mobile in translation relative to an additional bracket 104c parallel to the vertical direction Z.

The stud 502 projects upwardly from the upper longitudinal member 204.

Such an arrangement makes it possible to generate a hyperstatic arrangement which multiplies the force transfer paths. All of the forces are taken up in the region of the structure 104a of the wing 104 via the under-wing panel 104b which makes it possible to limit the forces on said under-wing panel 104b.

According to one particular arrangement, the stud 502 is also mobile in translation relative to the additional bracket 104c parallel to the longitudinal direction X. This arrangement ensures the transfer of forces in Y but avoids transmitting the forces in X.

FIGS. 4 to 6 show an embodiment of the connection between the stud 502 and the additional bracket 104c.

The assembly 1 comprises a ring 602 which is perforated by a central bore 602a which is fitted on the distal end of the stud 502, and where the stud 502 is mobile in translation in said central bore 602a parallel to the vertical direction Z. Moreover, the ring 602 has an external surface 602b which is spherical.

The assembly 1 also comprises a nut 604, the internal surface thereof being spherical and the ring 602 being housed therein. The ring 602 is thus mobile in rotation in the nut 604.

In this case, the assembly 1 also has a blocking plate 608 which is fixed to the nut 604, for example by screws, and which blocks the rotation of the nut 604 relative to the additional bracket 104c.

The ring 602, the nut 604 and the blocking plate 608 are housed in the aperture 601 of the additional bracket 104c, the shape thereof being suitable therefor.

In order to ensure the translation of the stud 502 parallel to a longitudinal direction X, the nut 604 has on its external surface two ribs 606 which are on either side of the nut 604 relative to the vertical median plane XZ. Each rib 606 is parallel to the longitudinal direction X and in this case takes the form of a cylinder portion.

On the edges of the aperture 601, for each rib 606, the additional bracket 104c has a recess 603 which extends parallel to the longitudinal direction X and in which said rib 606 is guided in translation.

For reasons of redundancy, the stud 502 consists in this case of two half-cylinders 502a-b which are on either side of a plane YZ perpendicular to the longitudinal direction X. The two half-cylinders 502a-b are thus contiguous along said plane YZ and the proximal end of each half-cylinder 502a-b is fixed to the upper longitudinal member 204, in this case by means of a shoe 506a-b which is fixed, for example, by screw elements to the upper longitudinal member 204. Thus in the case of the rupture of one or other of the half-cylinders 502a-b, the other takes over. To keep the two half-cylinders 502a-b contiguous with one another, the distal end of the stud 502 is covered by a sleeve 508.

The moment about the longitudinal direction X (Mx) is taken up by a differential of Z (vertical forces) applied by the fork ends 252a-b. The moment about the transverse direction Y (My) is taken up by two opposing forces in the front 254 and rear 256 links. The moment about the vertical direction Z (Mz) is taken up by a differential of X (axial forces) applied by the fork ends 252a-b.

In the case of the rupture of one of the front 254 and rear 256 links, the forces passing through this link are taken up by the other link and the fork ends 252a-b.

FIG. 3 shows a variant of the invention which makes it possible to compensate for a rupture of one of the fork ends 252a-b.

In addition to each fork end 252a-b, the assembly 1 comprises a complementary link 702, a first end thereof being mounted in an articulated manner on the structure 104a of the wing 104 and a second end thereof being mounted in an articulated manner on the lateral panel 208a-b which is on the same side. There are two complementary links 702 arranged on either side of the vertical median plane XZ.

The articulation of each end of the complementary links 702 in this case takes the form of a rotation about a complementary axis parallel to the axis of articulation 52, perpendicular to the vertical median plane XZ and parallel to the transverse direction Y.

Each articulation of a complementary link 702 is implemented in this case by a complementary shaft 704 which passes through a bore of said complementary link 702 and a bore respectively of the associated lateral panel 208a-b or the structure 104a of the wing 104. Thus there are two complementary shafts 704 for each complementary link 702.

To avoid the situation where the fork end 252a-b and the complementary link 702, which are on the same side, work at the same time, it is provided that the complementary link 702 intervenes only when the fork end 252a-b is faulty. To achieve this, it is provided that one of the bores of each complementary link 702 has a diameter which is greater than the diameter of the associated complementary shaft 704. Thus as long as the fork end 252a-b is not faulty, there is no contact between the complementary shaft 704 and the bore of the complementary link 702 of greater diameter, and when the fork end 252a-b ruptures, the rigid structure 202 is lowered, which entrains the complementary shaft 704 which thus comes into contact with the edge of the bore of greater diameter and the complementary link 702 can then ensure its role. In the embodiment of the invention shown here, it is the bore of the complementary link 702 corresponding to the connection with the lateral panel 208a-b which has a greater diameter.

Each complementary link 702 is mounted in this case on the structure 104a of the wing 104 by means of a complementary bracket 706 which is separate from the fork end 252a-b, which makes it possible to ensure additional safety in the case of the rupture of the fork end 252a-b.

According to a further embodiment, not shown, which also makes it possible to compensate for a rupture of one of the fork ends 252a-b, each element of the lateral fork end-panel connection is duplicated, i.e., in the region of the passage of the lateral shaft the lateral panel 208a-b is duplicated, i.e., there are two plates fixed to one another and passed through by the lateral shaft.

In the same manner, the two walls constituting the fork end 252a-b are duplicated, i.e., there are two plates fixed to one another and passed through by the lateral shaft. Thus in the case of the rupture of one of the walls, the wall which duplicates it takes over. In the same manner, the lateral shaft is duplicated and consists of a peripheral shaft which is cylindrical and hollow and an internal shaft which is fitted into the peripheral shaft. Thus in the case of a malfunction of the peripheral shaft, the internal shaft can take over.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An assembly for an aircraft comprising a wing with a structure, the assembly having a vertical direction and a vertical median plane and comprising:
an engine pylon having a primary structure forming a box and comprising a starboard lateral panel, a portside lateral panel, an upper longitudinal member, and a lower longitudinal member;
an additional bracket configured to be fixed to the structure of the wing;
a starboard fork end and a portside fork end arranged on either side of the vertical median plane, each configured to be fixed to the structure of the wing and each mounted in an articulated manner on a lateral panel which is on a same side;
a front link arranged in the vertical median plane, an upstream end thereof mounted in an articulated manner on the upper longitudinal member and a downstream end thereof mounted in an articulated manner on the additional bracket;
a rear link arranged in the vertical median plane, an upstream end thereof mounted in an articulated manner on the lower longitudinal member and a downstream end thereof configured to be mounted in an articulated manner on the structure of the wing; and,
a stud having an axis parallel to the vertical direction and having a proximal end integral with the upper longitudinal member and a distal end mounted in an aperture of the additional bracket via an annular linear connection.

2. The assembly according to claim 1, wherein the stud is mobile in translation relative to the additional bracket parallel to a longitudinal direction.

3. The assembly according to claim 2, further comprising:
a ring which has a spherical external surface and which is fitted over the distal end of the stud; and,
a nut which has a spherical internal surface in which the ring is housed,
wherein, on either side of the nut, an external surface of the nut has a rib parallel to the longitudinal direction,
wherein, on edges of an aperture, the additional bracket has, for each rib, a recess extending parallel to the longitudinal direction in which said rib is guided in translation.

4. The assembly according to claim 1, wherein the stud comprises two half-cylinders which are contiguous along a plane, and
wherein a proximal end of each half-cylinder is fixed to the upper longitudinal member.

5. The assembly according to claim 1, wherein each articulation comprises a rotation about an axis perpendicular to the vertical median plane.

6. The assembly according to claim 1, wherein, for each fork end, the assembly comprises a complementary link with a first end configured to be mounted in an articulated manner on the structure of the wing and a second end mounted in an articulated manner on a lateral panel which is on a same side.

7. The assembly according to claim 6, wherein each articulation of a complementary link comprises a complementary shaft which passes through a bore of said complementary link and a bore, respectively, of the lateral panel or the structure of the wing.

8. The assembly according to claim 7, wherein the bore of the complementary link corresponding to a connection to the lateral panel has a diameter which is greater than a diameter of the complementary shaft.

9. An aircraft comprising:
a wing with a structure;
a turbojet; and
an assembly according to claim 1,
wherein the additional bracket is fixed to the structure of the wing,
wherein each fork end is fixed to the structure of the wing,
wherein the downstream end of the rear link is mounted in an articulated manner on the structure of the wing, and
wherein the turbojet is fixed below the engine pylon.
